(19) United States
(12) Patent Application Publication
(10) Pub. No.: US 2019/0029064 A1
(43) Pub. Date: Jan. 24, 2019

(54) Method And Apparatus For Handling Re-Attempt Indicator In Mobile Communications

(71) Applicant: MediaTek Inc., Hsinchu City (TW)

(72) Inventor: Syue-Ju Syue, Hsinchu City (TW)

(21) Appl. No.: 16/039,281

(22) Filed: Jul. 18, 2018

Related U.S. Application Data
(60) Provisional application No. 62/534,272, filed on Jul. 19, 2017.

(51) Int. Cl. H04W 76/18; H04W 48/16; H04W 48/12; H04W 48/02

(52) U.S. Cl. CPC H04W 76/18; H04W 48/02; H04W 48/12; H04W 48/16

(57) ABSTRACT

Various solutions for handling re-attempt indicator with respect to user equipment and network apparatus in mobile communications are described. An apparatus may receive a reject message without a back-off timer value from a network node. The apparatus may start a back-off timer by using a predetermined timer value. The apparatus may perform a re-attempt procedure according to a re-attempt indicator.

### CROSS REFERENCE TO RELATED PATENT APPLICATION(S)

The present disclosure is part of a non-provisional application claiming the priority benefit of U.S. patent application Ser. No. 62/534,272, filed on 19 Jul. 2017, the content of which is incorporated by reference in its entirety.

### TECHNICAL FIELD

The present disclosure is generally related to mobile communications and, more particularly, to handling re-attempt indicator with respect to user equipment and network apparatus in mobile communications.

### BACKGROUND

Unless otherwise indicated herein, approaches described in this section are not prior art to the claims listed below and are not admitted as prior art by inclusion in this section.

Based on the 3^{rd} generation partnership project (3GPP) specifications, when the user equipment (UE) establishes a session with a network apparatus, the network apparatus may include a back-off timer value in a session management reject message to regulate the time interval within which the UE is not allowed to retry the same procedure. The network apparatus may also include a re-attempt indicator in the reject message to indicate whether the UE is allowed to retry the corresponding session management procedure for the same access point name (APN) in A/Gb mode, Iu mode or S1 mode after inter-system change.

However, in a case that the back-off timer is not included in the reject message, the UE shall ignore the re-attempt indicator provided by the network apparatus in the reject message. Additionally, for some certain reject cause values, the UE shall start the back-off timer by using a predetermined timer value regardless of the presence of the back-off timer in the reject message. The UE may also ignore the re-attempt indicator provided by the network apparatus after starting the back-off timer. As a consequence, the network apparatus in such scenarios may be unable to control the UE behaviors regarding the permission to retry the same procedure. The UE may keep retrying the same procedure without limitation. Such UE behaviors may exhaust UE's power and waste radio resources.

Accordingly, how to properly perform the retry procedure and avoid unnecessary retry procedure may affect UE's power consumption and radio resource efficiency. It is needed to provide proper design for handling the re-attempt indicator and performing the retry procedure accordingly.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to handling re-attempt indicator with respect to user equipment and network apparatus in mobile communications.

In one aspect, a method may involve an apparatus receiving a reject message without a back-off timer value from a network node. The method may also involve the apparatus starting a back-off timer by using a predetermined timer value. The method may further involve the apparatus performing a re-attempt procedure according to a re-attempt indicator.

In one aspect, a method may involve an apparatus receiving a reject message with a back-off timer value from a network node. The method may also involve the apparatus determining whether a re-attempt indicator is received from the network node. The method may further involve the apparatus performing a re-attempt procedure according to a predetermined re-attempt indicator in response to no re-attempt indicator received from the network node.

In one aspect, an apparatus may comprise a transceiver capable of wirelessly communicating with a plurality of nodes of a wireless network. The apparatus may also comprise a processor communicatively coupled to the transceiver. The processor may be capable of receiving a reject message without a back-off timer value from a network node. The processor may also be capable of starting a back-off timer by using a predetermined timer value. The processor may further be capable of performing a re-attempt procedure according to a re-attempt indicator.

In one aspect, an apparatus may comprise a transceiver capable of wirelessly communicating with a plurality of nodes of a wireless network. The apparatus may also comprise a processor communicatively coupled to the transceiver. The processor may be capable of receiving a reject message with a back-off timer value from a network node. The processor may also be capable of determining whether a re-attempt indicator is received from the network node. The processor may further be capable of performing a re-attempt procedure according to a predetermined re-attempt indicator in response to no re-attempt indicator received from the network node.

It is noteworthy that, although description provided herein may be in the context of certain radio access technologies, networks and network topologies such as Global System for Mobile communications (GSM), Universal Mobile Telecommunications System (UMTS), Long-Term Evolution (LTE), LTE-Advanced, LTE-Advanced Pro, 5th Generation (5G) and New Radio (NR), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scheme under schemes in accordance with implementations of the present disclosure.

FIG. 2 is a diagram depicting an example re-attempt indicator under schemes in accordance with implementations of the present disclosure.

FIG. 3 is a block diagram of an example communication apparatus and an example network apparatus in accordance with an implementation of the present disclosure.

FIG. 4 is a flowchart of an example process in accordance with an implementation of the present disclosure.

FIG. 5 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to handling re-attempt indicator with respect to user equipment and network apparatus in mobile communications. According to the present disclosure, a number of possible solutions may be implemented separately or jointly. That is, although these possible solutions may be described below separately, two or more of these possible solutions may be implemented in one combination or another.

Based on the 3GPP specifications, when the UE establishes a session with the network apparatus, the network apparatus may include a back-off timer value in a session management reject message to regulate the time interval within which the UE is not allowed to retry the same procedure. For EPS session management (ESM) or SM cause values other than the cause value #26 representing “insufficient resources”, the network apparatus may also include a re-attempt indicator in the reject message to indicate whether the UE is allowed to retry the corresponding session management procedure for the same APN in A/Gb mode, Iu mode or S1 mode after inter-system change.

Generally, in a case that the back-off timer is not included in the reject message, the UE shall ignore the re-attempt indicator provided by the network apparatus in the reject message. Additionally, for some certain reject cause values, the UE shall start the back-off timer regardless of the presence of the back-off timer in the reject message. The UE may also ignore the re-attempt indicator provided by the network apparatus after starting the back-off timer. As a consequence, the network apparatus in such scenarios may be unable to control the UE behaviors regarding the permission to retry the same procedure. The UE may keep retrying the same procedure without limitation. Such UE behaviors may exhaust UE's power and waste radio resources.

In view of the above, the present disclosure proposes a number of schemes pertaining to handling the re-attempt indicator. According to the schemes of the present disclosure, the re-attempt indicator should be taken into consideration rather than ignored for certain cause values even if the network apparatus does not include the back-off timer in the reject message. For some certain cause values, the UE should start the back-off timer and follow the setting of the re-attempt indicator in a case that the re-attempt indicator is received from the network apparatus. Alternatively, the UE should apply a predetermined re-attempt indicator in a case that no re-attempt indicator is received from the network apparatus.

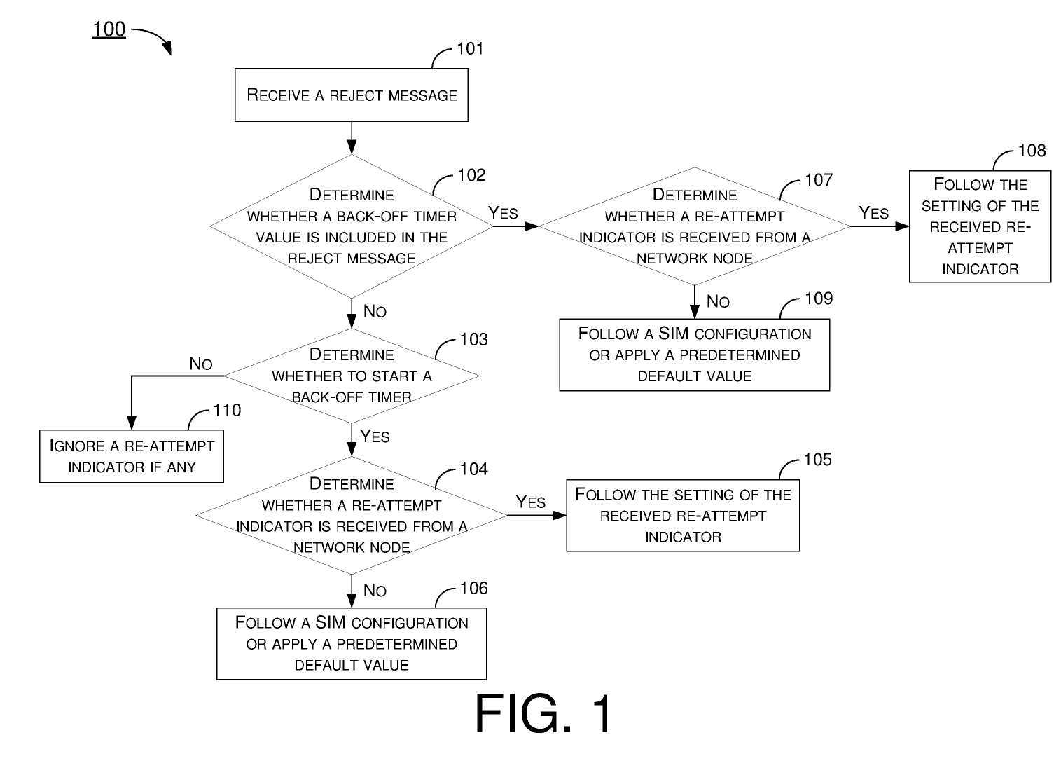

FIG. 1 illustrates an example scheme 100 in accordance with implementations of the present disclosure. Scheme 100 may involve a UE and a network apparatus, which may be a part of a wireless communication network (e.g., a GSM network, a UMTS network, an LTE network, an LTE-Advanced network, an LTE-Advanced Pro network, a 5G network or an NR network). The UE may be configured to establish a session with the network apparatus. The UE may be configured to transmit a request message to the network apparatus. The request message may comprise, for example and without limitation, a PDN connectivity request message, an activate packet data protocol (PDP) context request message, a bearer resource allocation request message, or an activate secondary PDP context request message. In response to the request message, the network apparatus may be configured to transmit a reject message to the UE. The reject message may comprise, for example and without limitation, a PDN connectivity reject message, a PDP context reject message, a bearer resource allocation reject message, or an activate secondary PDP context reject message.

Referring to FIG. 1, scheme 100 may involve a number of operations and/or actions performed by the UE for handling the re-attempt indicator as represented by one or more of blocks 101, 102, 103, 104, 105, 106, 107, 108, 109 and 110. Although illustrated as discrete blocks, various blocks of scheme 100 may be divided into additional blocks, combined into fewer blocks, or eliminated, depending on the desired implementation. Scheme 100 may be implemented by communication apparatus 310 described below. Scheme 100 may begin at 101.

At 101, the UE may be configured to receive a reject message from the network apparatus. Scheme 100 may proceed from 101 to 102.

At 102, the UE may be configured to determine whether a back-off timer value is included in the reject message. If yes, scheme 100 may proceed from 102 to 107. If no, scheme 100 may proceed from 102 to 103.

At 103, the UE may be configured to determine whether to start a back- off timer. If the UE determines not to start a back-off timer or the timer value of the back-off timer is zero, scheme 100 may proceed from 103 to 110. If the UE determines to start a back-off timer, scheme 100 may proceed from 103 to 104.

Since the back-off timer value is not included in the reject message, the UE may be configured to start the back-off timer with a non-zero timer length by using a predetermined timer value. The predetermined timer value may be stored in a subscriber identity module (SIM) configuration. For example, the predetermined timer value may be the configured SM_RetryWaitTime value in UMTS SIM (USIM) file NAS_{CONFIG}. Alternatively, the predetermined timer value may be a predetermined default value. For example, the predetermined default value may be 12 minutes.

At 104, the UE may be configured to determine whether a re-attempt indicator is received from the network apparatus. If yes, scheme 100 may proceed from 104 to 105. If no, scheme 100 may proceed from 104 to 106.

At 105, the UE may be configured to follow the setting of the received re-attempt indicator. The re-attempt indicator may be provided by the network apparatus in the reject message. Specifically, the UE may be configured to perform a re-attempt procedure according to the re-attempt indicator received from the network apparatus.

At 106, the UE may be configured to follow a SIM configuration or apply a predetermined default value. Since the re-attempt indicator is not included in the reject message, the UE may be configured to perform a re-attempt procedure according to a predetermined re-attempt indicator. The predetermined re-attempt indicator may be stored in a SIM configuration. For example, the predetermined re-attempt indicator may be the configured SM_RetryAtRATChange value in USIM file NAS_{CONFIG}. Alternatively, the predetermined re-attempt indicator may be a predetermined default value. The predetermined default value may be pre-defined by an operator or service provider, or may be determined depending on the UE implementation.

At 107, after receiving a reject message with a back-off timer value from the network apparatus, the UE may be configured to determine whether a re-attempt indicator is received from the network apparatus. If yes, scheme 100 may proceed from 104 to 108. If no, scheme 100 may proceed from 104 to 109.

At 108, the UE may be configured to follow the setting of the received re-attempt indicator. The re-attempt indicator may be provided by the network apparatus in the reject message. Specifically, the UE may be configured to perform a re-attempt procedure according to the received re-attempt indicator in response to receiving the re-attempt indicator from the network apparatus.

At 109, the UE may be configured to follow a SIM configuration or apply a predetermined default value. The UE may be configured to perform a re-attempt procedure according to a predetermined re-attempt indicator in response to no re-attempt indicator received from the network apparatus. The predetermined re-attempt indicator may be stored in a SIM configuration. For example, the predetermined re-attempt indicator may be the configured SM_RetryAtRATChange value in USIM file NAS_{CONFIG}. Alternatively, the predetermined re-attempt indicator may be a predetermined default value. The predetermined default value may be pre-defined by an operator or service provider, or may be determined depending on the UE implementation.

At 110, the UE may be configured to ignore a re-attempt indicator if any.

In some implementations, the reject message received by the UE in block 101 may comprise a reject cause value. The reject cause value may comprise, for example and without limitation, a reject cause #8, a reject cause #27, a reject cause #32, or a reject cause #33. The reject cause #8 may represent “operator determined barring”. The reject cause #27 may represent “missing or unknown APN”. The reject cause #32 may represent “service option not supported”. The reject cause #33 may represent “requested service option not supported”. Scheme 100 may be applied to the reject message with the reject cause #8, #27, #32, or #33. Alternatively, scheme 100 may also be applied to the reject message with the reject cause other than #8, #27, #32, or #33.

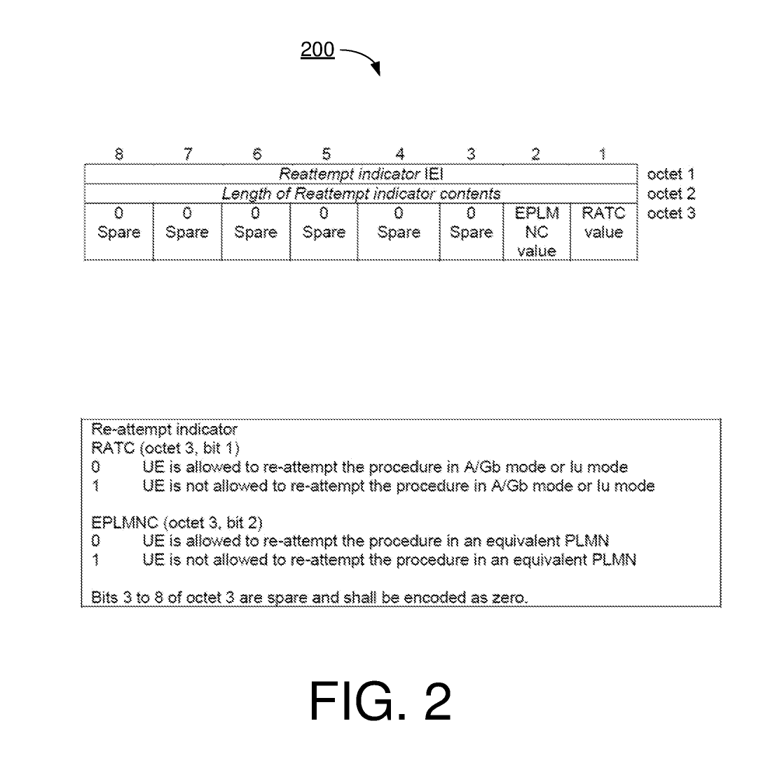

FIG. 2 illustrates an example re-attempt indicator 200 under schemes in accordance with implementations of the present disclosure. Re-attempt indicator 200 may be implemented as in information element. The re-attempt indicator information element may be transmitted from the network apparatus to the UE. The re-attempt indicator information element may comprise a plurality of bits (e.g., 8 bits). One bit (e.g., bit 1) may be used to indicate whether the UE is allowed to re-attempt the procedure in a different radio access technology (RAT) (e.g., RATC value). For example, bit value “0” of the RATC value may be used to indicate that the UE is allowed to re-attempt the procedure in A/Gb mode or Iu mode. Bit value “1” of the RATC value may be used to indicate that the UE is not allowed to re-attempt the procedure in A/Gb mode or Iu mode. Another bit (e.g., bit 2) may be used to indicate whether the UE is allowed to re-attempt the procedure in an equivalent public land mobile network (PLMN) (e.g., EPLMNC value). For example, bit value “0” of the EPLMNC value may be used to indicate that the UE is allowed to re-attempt the procedure in an equivalent PLMN. Bit value “1” of the EPLMNC value may be used to indicate that the UE is not allowed to re-attempt the procedure in an equivalent PLMN. The other bits (e.g., bit 3 to 8) may be spare bits and may be encoded as zero.

### Illustrative Implementations

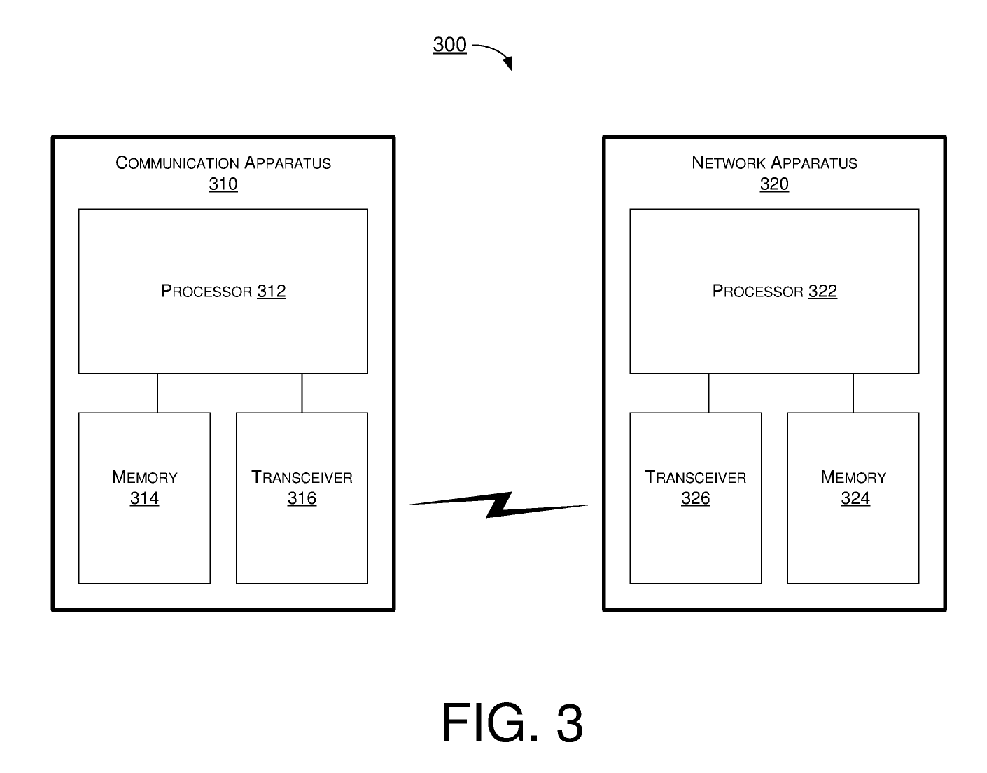

FIG. 3 illustrates an example communication apparatus 310 and an example network apparatus 320 in accordance with an implementation of the present disclosure. Each of communication apparatus 310 and network apparatus 320 may perform various functions to implement schemes, techniques, processes and methods described herein pertaining to handling re-attempt indicator with respect to user equipment and network apparatus in wireless communications, including schemes described above as well as processes 400 and 500 described below.

Communication apparatus 310 may be a part of an electronic apparatus, which may be a UE such as a portable or mobile apparatus, a wearable apparatus, a wireless communication apparatus or a computing apparatus. For instance, communication apparatus 310 may be implemented in a smartphone, a smartwatch, a personal digital assistant, a digital camera, or a computing equipment such as a tablet computer, a laptop computer or a notebook computer. Communication apparatus 310 may also be a part of a machine type apparatus, which may be an IoT or NB-IoT apparatus such as an immobile or a stationary apparatus, a home apparatus, a wire communication apparatus or a computing apparatus. For instance, communication apparatus 310 may be implemented in a smart thermostat, a smart fridge, a smart door lock, a wireless speaker or a home control center. Alternatively, communication apparatus 310 may be implemented in the form of one or more integrated-circuit (IC) chips such as, for example and without limitation, one or more single-core processors, one or more multi-core processors, or one or more complex-instruction-set-computing (CISC) processors. Communication apparatus 310 may include at least some of those components shown in FIG. 3 such as a processor 312, for example. Communication apparatus 310 may further include one or more other components not pertinent to the proposed scheme of the present disclosure (e.g., internal power supply, display device and/or user interface device), and, thus, such component(s) of communication apparatus 310 are neither shown in FIG. 3 nor described below in the interest of simplicity and brevity.

Network apparatus 320 may be a part of an electronic apparatus, which may be a network node such as a base station, a small cell, a router or a gateway. For instance, network apparatus 320 may be implemented in a base station in a GSM or UMTS network, in an eNodeB in an LTE, LTE-Advanced or LTE-Advanced Pro network or in a gNB in a 5G, NR, IoT or NB-IoT network. Alternatively, network apparatus 320 may be implemented in the form of one or more IC chips such as, for example and without limitation, one or more single-core processors, one or more multi-core processors, or one or more CISC processors. Network apparatus 320 may include at least some of those components shown in FIG. 3 such as a processor 322, for example. Network apparatus 320 may further include one or more other components not pertinent to the proposed scheme of the present disclosure (e.g., internal power supply, display device and/or user interface device), and, thus, such component(s) of network apparatus 320 are neither shown in FIG. 3 nor described below in the interest of simplicity and brevity.

In one aspect, each of processor 312 and processor 322 may be implemented in the form of one or more single-core processors, one or more multi-core processors, or one or more CISC processors. That is, even though a singular term “a processor” is used herein to refer to processor 312 and processor 322, each of processor 312 and processor 322 may include multiple processors in some implementations and a single processor in other implementations in accordance with the present disclosure. In another aspect, each of processor 312 and processor 322 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 312 and processor 322 is a special-purpose machine specifically designed, arranged and configured to perform specific tasks including power consumption reduction in a device (e.g., as represented by communication apparatus 310) and a network (e.g., as represented by network apparatus 320) in accordance with various implementations of the present disclosure.

In some implementations, communication apparatus 310 may also include a transceiver 316 coupled to processor 312 and capable of wirelessly transmitting and receiving data. In some implementations, communication apparatus 310 may further include a memory 314 coupled to processor 312 and capable of being accessed by processor 312 and storing data therein. In some implementations, network apparatus 320 may also include a transceiver 326 coupled to processor 322 and capable of wirelessly transmitting and receiving data. In some implementations, network apparatus 320 may further include a memory 324 coupled to processor 322 and capable of being accessed by processor 322 and storing data therein. Accordingly, communication apparatus 310 and network apparatus 320 may wirelessly communicate with each other via transceiver 316 and transceiver 326, respectively. To aid better understanding, the following description of the operations, functionalities and capabilities of each of communication apparatus 310 and network apparatus 320 is provided in the context of a mobile communication environment in which communication apparatus 310 is implemented in or as a communication apparatus or a UE and network apparatus 320 is implemented in or as a network node of a communication network.

In some implementations, processor 312 may be configured to establish a session with network apparatus 320. Processor 312 may be configured to transmit, via transceiver 316, a request message to network apparatus 320. Processor 312 may transmit, for example and without limitation, a PDN connectivity request message, a PDP context request message, a bearer resource allocation request message, or an activate secondary PDP context request message to network apparatus 320. In response to the request message, processor 322 may be configured to transmit, via transceiver 326, a reject message to communication apparatus 310. Processor 322 may transmit, for example and without limitation, a PDN connectivity reject message, a PDP context reject message, a bearer resource allocation reject message, or an activate secondary PDP context reject message to communication apparatus 310.

In some implementations, processor 312 may be configured to receive a reject message, and determine whether a back-off timer value is included in the reject message.

In some implementations, processor 312 may be configured to whether to start a back-off timer. In a case that the back-off timer value is not included in the reject message, processor 312 may be configured to start the back-off timer with a non-zero timer length by using a predetermined timer value. Processor 312 may use the predetermined timer value stored in a SIM configuration. For example, processor 312 may use the configured SM_RetryWaitTime value in UMTS SIM (USIM) file NAS_{CONFIG}. In some implementations, processor 312 may use a predetermined default value. For example, processor 312 may use 12 minutes as the predetermined timer value.

In some implementations, processor 312 may be configured to determine whether a re-attempt indicator is received from network apparatus 320. In a case that the re-attempt indicator is received from network apparatus 320, processor 312 may be configured to follow the setting of the received re-attempt indicator. Processor 312 may receive the re-attempt indicator in the reject message. Processor 312 may be configured to perform a re-attempt procedure according to the re-attempt indicator received from network apparatus 320.

In some implementations, in a case that no re-attempt indicator is received from network apparatus 320, processor 312 may be configured to follow a SIM configuration or apply a predetermined default value. Since no re-attempt indicator is not included in the reject message, processor 312 may be configured to perform a re-attempt procedure according to a predetermined re-attempt indicator. Processor 312 may use the predetermined re-attempt indicator stored in a SIM configuration. For example, processor 312 may use the configured SM_RetryAtRATChange value in USIM file NAS_{CONFIG}. In some implementations, processor 312 may use a predetermined default value for the re-attempt indicator. The predetermined default value may be pre-defined by an operator or service provider, or may be determined depending on the implementation.

In some implementations, after receiving a reject message with a back-off timer value from network apparatus 320, processor 312 may be configured to further determine whether a re-attempt indicator is received from network apparatus 320. In a case that the re-attempt indicator is received from network apparatus 320, processor 312 may be configured to follow the setting of the received re-attempt indicator. Processor 312 may receive the re-attempt indicator in the reject message. Processor 312 may be configured to perform a re-attempt procedure according to the received re-attempt indicator in response to receiving the re-attempt indicator from network apparatus 320.

In some implementations, in a case that no re-attempt indicator is received from network apparatus 320, processor 312 may be configured to follow a SIM configuration or apply a predetermined default value. Processor 312 may be configured to perform a re-attempt procedure according to a predetermined re-attempt indicator in response to no re-attempt indicator received from network apparatus 320. Processor 312 may use the predetermined re-attempt indicator stored in a SIM configuration. For example, processor 312 may use the configured SM_RetryAtRATChange value in USIM file NAS_{CONFIG}. In some implementations, processor 312 may use a predetermined default value for the predetermined re-attempt indicator. The predetermined default value may be pre-defined by an operator or service provider, or may be determined depending on the implementation.

In some implementations, processor 312 may be configured to ignore a re-attempt indicator if any in response to no back-off timer is started.

In some implementations, processor 312 may transmit a reject message with a reject cause value. The reject cause value may comprise, for example and without limitation, a reject cause #8, a reject cause #27, a reject cause #32, or a reject cause #33.

### Illustrative Processes

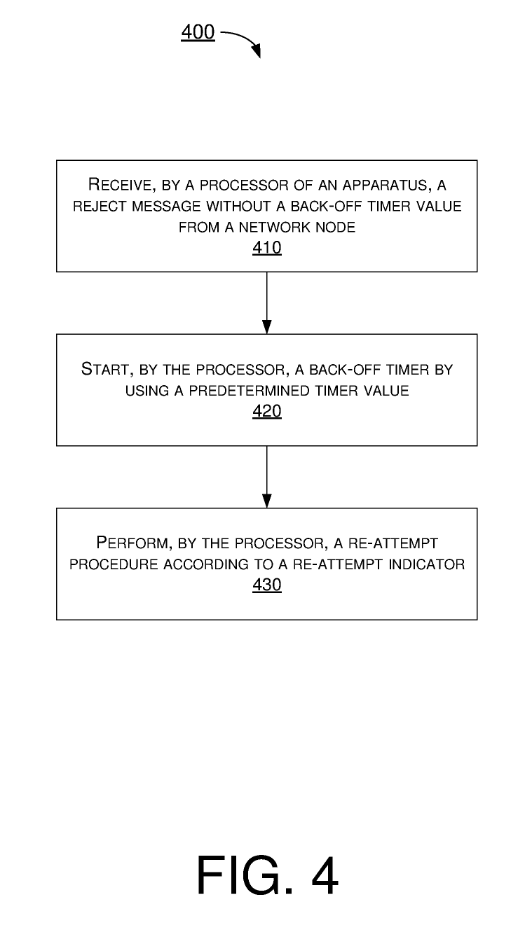

FIG. 4 illustrates an example process 400 in accordance with an implementation of the present disclosure. Process 400 may be an example implementation of scenarios described above, whether partially or completely, with respect to handling re-attempt indicator in accordance with the present disclosure. Process 400 may represent an aspect of implementation of features of communication apparatus 310. Process 400 may include one or more operations, actions, or functions as illustrated by one or more of blocks 410, 420 and 430. Although illustrated as discrete blocks, various blocks of process 400 may be divided into additional blocks, combined into fewer blocks, or eliminated, depending on the desired implementation. Moreover, the blocks of process 400 may be executed in the order shown in FIG. 4 or, alternatively, in a different order. Process 400 may be implemented by communication apparatus 310 or any suitable UE or machine type devices. Solely for illustrative purposes and without limitation, process 400 is described below in the context of communication apparatus 310. Process 400 may begin at block 410.

At 410, process 400 may involve processor 312 of communication apparatus 310 receiving a reject message without a back-off timer value from a network node. Process 400 may proceed from 410 to 420.

At 420, process 400 may involve processor 312 starting a back-off timer by using a predetermined timer value. Process 400 may proceed from 420 to 430.

At 430, process 400 may involve processor 312 performing a re-attempt procedure according to a re-attempt indicator.

In some implementations, the re-attempt indicator may be received from the network node.

In some implementations, the re-attempt indicator may be stored in a SIM configuration, or a predetermined default value.

In some implementations, the reject message may comprise a reject cause value. The reject cause value may comprise at least one of a reject cause #8, a reject cause #27, a reject cause #32, or a reject cause #33.

In some implementations, the reject message may comprise at least one of a PDN connectivity reject message, a PDP context reject message, a bearer resource allocation reject message, or an activate secondary PDP context reject message.

In some implementations, the predetermined timer value may be stored in a SIM configuration, or a predetermined default value.

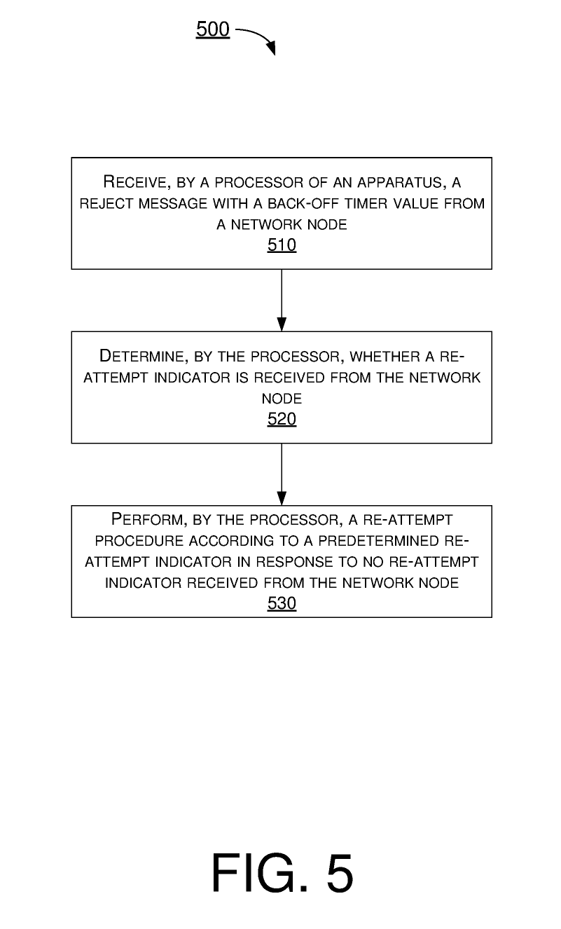

FIG. 5 illustrates an example process 500 in accordance with an implementation of the present disclosure. Process 500 may be an example implementation of scenarios described above, whether partially or completely, with respect to handling re-attempt indicator in accordance with the present disclosure. Process 500 may represent an aspect of implementation of features of communication apparatus 310. Process 500 may include one or more operations, actions, or functions as illustrated by one or more of blocks 510, 520 and 530. Although illustrated as discrete blocks, various blocks of process 500 may be divided into additional blocks, combined into fewer blocks, or eliminated, depending on the desired implementation. Moreover, the blocks of process 500 may be executed in the order shown in FIG. 5 or, alternatively, in a different order. Process 500 may be implemented by communication apparatus 310 or any suitable UE or machine type devices. Solely for illustrative purposes and without limitation, process 500 is described below in the context of communication apparatus 310. Process 500 may begin at block 510.

At 510, process 500 may involve processor 312 of communication apparatus 310 receiving a reject message with a back-off timer value from a network node. Process 500 may proceed from 510 to 520.

At 520, process 500 may involve processor 312 determining whether a re-attempt indicator is received from the network node. Process 500 may proceed from 520 to 530.

At 530, process 500 may involve processor 312 performing a re-attempt procedure according to a predetermined re-attempt indicator in response to no re-attempt indicator received from the network node.

In some implementations, the predetermined re-attempt indicator may be stored in a SIM configuration, or a predetermined default value.

In some implementations, the reject message may comprise at least one of a PDN connectivity reject message, a PDP context reject message, a bearer resource allocation reject message, or an activate secondary PDP context reject message.

In some implementations, process 500 may involve processor 312 performing the re-attempt procedure according to the received re-attempt indicator in response to receiving the re-attempt indicator from the network node.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, a reject message without a back-off timer value from a network node;
starting, by the processor, a back-off timer by using a predetermined timer value; and
performing, by the processor, a re-attempt procedure according to a re-attempt indicator.

2. The method of claim 1, wherein the re-attempt indicator is received from the network node.

3. The method of claim 1, wherein the re-attempt indicator is stored in a subscriber identity module (SIM) configuration, or a predetermined default value.

4. The method of claim 1, wherein the reject message comprises a reject cause value, and wherein the reject cause value comprises at least one of a reject cause #8, a reject cause #27, a reject cause #32, or a reject cause #33.

5. The method of claim 1, wherein the reject message comprises at least one of a packet data network (PDN) connectivity reject message, an activate packet data protocol (PDP) context reject message, a bearer resource allocation reject message, or an activate secondary PDP context reject message.

6. The method of claim 1, wherein the predetermined timer value is stored in a subscriber identity module (SIM) configuration, or a predetermined default value.

7. A method, comprising:
receiving, by a processor of an apparatus, a reject message with a back-off timer value from a network node;
determining, by the processor, whether a re-attempt indicator is received from the network node; and
performing, by the processor, a re-attempt procedure according to a predetermined re-attempt indicator in response to no re-attempt indicator received from the network node.

8. The method of claim 7, wherein the predetermined re-attempt indicator is stored in a subscriber identity module (SIM) configuration, or a predetermined default value.

9. The method of claim 7, wherein the reject message comprises at least one of a packet data network (PDN) connectivity reject message, an activate packet data protocol (PDP) context reject message, a bearer resource allocation reject message, or an activate secondary PDP context reject message.

10. The method of claim 7, further comprising:
performing, by the processor, the re-attempt procedure according to the received re-attempt indicator in response to receiving the re-attempt indicator from the network node.

11. An apparatus, comprising:
a transceiver capable of wirelessly communicating with a plurality of nodes of a wireless network; and
a processor communicatively coupled to the transceiver, the processor capable of:
receiving, via the transceiver, a reject message without a back-off timer value from a network node;
starting a back-off timer by using a predetermined timer value; and
performing a re-attempt procedure according to a re-attempt indicator.

12. The apparatus of claim 11, wherein the re-attempt indicator is received from the network node.

13. The apparatus of claim 11, wherein the re-attempt indicator is stored in a subscriber identity module (SIM) configuration, or a predetermined default value.

14. The apparatus of claim 11, wherein the reject message comprises a reject cause value, and wherein the reject cause value comprises at least one of a reject cause #8, a reject cause #27, a reject cause #32, or a reject cause #33.

15. The apparatus of claim 11, wherein the reject message comprises at least one of a packet data network (PDN) connectivity reject message, an activate packet data protocol (PDP) context reject message, a bearer resource allocation reject message, or an activate secondary PDP context reject message.

16. The apparatus of claim 11, wherein the predetermined timer value is stored in a subscriber identity module (SIM) configuration, or a predetermined default value.

17. An apparatus, comprising:
a transceiver capable of wirelessly communicating with a plurality of nodes of a wireless network; and
a processor communicatively coupled to the transceiver, the processor capable of:
receiving, via the transceiver, a reject message with a back-off timer value from a network node;
determining whether a re-attempt indicator is received from the network node; and
performing a re-attempt procedure according to a predetermined re-attempt indicator in response to no re-attempt indicator received from the network node.

18. The apparatus of claim 17, wherein the predetermined re-attempt indicator is stored in a subscriber identity module (SIM) configuration, or a predetermined default value.

19. The apparatus of claim 17, wherein the reject message comprises at least one of a packet data network (PDN) connectivity reject message, an activate packet data protocol (PDP) context reject message, a bearer resource allocation reject message, or an activate secondary PDP context reject message.

20. The apparatus of claim 17, wherein the processor is further capable of:
performing the re-attempt procedure according to the received re-attempt indicator in response to receiving the re-attempt indicator from the network node.
